(19) United States
(12) Patent Application Publication
(10) Pub. No.: US 2008/0272266 A1
(43) Pub. Date: Nov. 6, 2008

(54) High capacity work table having K-shaped legs for improved stability

(76) Inventors: Brian Eustace, Sierra Madre, CA (US); Dan Aurel David, La Canada, CA (US); Harry Randall Taylor, Whittier, CA (US)

Correspondence Address: CHRISTIE, PARKER & HALE, LLP, PO BOX 7068, PASADENA, CA, 91109-7068, US

(21) Appl. No.: 11/800,409

(22) Filed: May 4, 2007

(51) Int. Cl. F16M 11/00

(52) U.S. Cl. 248/423; 108/147.21

(57) ABSTRACT

A work table is provided having a table top and a pair of K-shaped leg supports. The K-shaped leg supports are attached to left and right underside portions of the table top. The K-shaped leg supports each include a vertical back leg, an upper front leg, and a lower front leg formed in the shape of a K. The upper front leg extends rearwardly and downwardly toward the back leg and is attached to one or both of the back leg or a rearward portion of the lower front leg. The lower front leg extends from a forward end rearwardly and upwardly and is attached at its rearward end to one or both of the back leg and a rearward portion of the upper front leg. The front edge of the lower front leg preferably extends forwardly slightly beyond the front edge of the table top.

### BACKGROUND OF THE INVENTION

1. Field of the Invention

The present invention relates generally to a work table, and more particularly to a high capacity work table having K-shaped legs for improved stability.

2. Description of Related Art

Work tables having table top and one or more leg supports are known in the art. In such work tables the leg supports may include a plurality of legs about the periphery of the table top or one or more pedestal style legs. For example, a work table may include a generally rectangle table top supported by four corner legs. Alternatively, a rectangular table top may be supported by a pair of end pedestal legs, or even by a single middle pedestal leg support. Work tables having a plurality of legs about the periphery of the tabletop provide stable support for the heavy loads resting on the table top. However, one difficulty encountered is that legs adjacent the periphery of the table top are often bumped, e.g., by a person's knee, when sitting or working at the table. Such contact may jar and knock over objects sitting on the table top.

Pedestal type tables lessen problems arising from bumping of the table legs because the support legs are generally recessed. However, pedestal type tables tend to provide less stable support for objects on the table top. For example, a pedestal-type table may be more prone to rock when a load is placed on the table top, particularly close to its periphery. Thus, there is a need for a work table that provides stability when loads are placed on the table top, particularly on a front portion or rear of the table top, while at the same time minimizing the tendency for frequent bumping into the legs.

### SUMMARY OF THE INVENTION

According to the present invention, there is provided a support structure for a work table top. The support structure is attachable to the underside of a table top, and includes a generally vertical back leg, an upper front leg, and a lower front leg forming a support structure substantially in the shape of a “K” (referred to herein as a “K-leg” or “K-leg support”). The upper front leg of the K leg support extends from an upper forward end rearwardly and downwardly and is fixedly attached at its rearward end to one or both of the vertical back leg or a rearward portion of a lower front leg. The lower front leg of the K leg support extends from a lower forward end rearwardly and upwardly and is fixedly attached to one or both of the vertical back leg or a rearward portion of the upper front leg.

In an exemplary embodiment of the invention, the top of the vertical back leg and the upper front end of the upper front leg are at about the same elevation and the bottom of the vertical back leg and the lower front end of the lower front leg are at about the same elevation. Hence the vertical distance between the top and bottom of the vertical back leg is about the same as the vertical distance between the upper front end of the front leg and the lower front end of the front leg.

In an exemplary embodiment of the present invention, the upper front leg is attached directly to the vertical back leg and the lower front leg is attached to a rearward portion of the upper front leg.

In another exemplary embodiment of the present invention, the lower front leg is attached directly to the vertical back leg, and the upper front leg is attached to a rearward portion of the lower front leg.

In another exemplary embodiment the upper front leg and lower front leg are each attached in whole or in part to the vertical back leg.

In another exemplary embodiment of the present invention, the lower front end of the lower front leg extends forwardly from the back leg a distance greater than the distance between the upper front end of the upper front leg and the back leg.

In another exemplary embodiment of the present invention, the angle between the upper front leg and the generally vertical back leg is from about 30° to about 60°, preferably from about 40° to about 50° and more preferably about 45°. Likewise, the angle between the lower front leg and the generally vertical back leg is from about 30° to about 60°, preferably from about 40° to about 50° and more preferably about 45°.

In another exemplary embodiment of the present invention, at least one of the top end of the back leg and the upper front end of the upper front leg comprises a flange having one or more holes for fixed attachment to the underside of a table top by means of screws, bolts or the like.

In another exemplary embodiment of the present invention, top end of the back leg and the upper front end of the upper front leg are hingedly attachable to the underside of a table top. In such an embodiment, if desired, the back leg of the K-leg support may be telescoping to enable a table top to be canted or tilted at one or more incline angles.

In another exemplary embodiment of the present invention, the K-leg support includes a top plate connecting the top end of the vertical back leg and the front end of the upper front leg. The top plate may have a plurality of holes for allowing the top plate to be attached to the underside of a table top by means of screws, bolts or the like. Alternatively, the top plate comprises one or more hinges allowing the K-leg support structure to be hingedly attached to the underside of the tape top. In this latter arrangement, the K-leg support can swing between an open support position and a folded position adjacent the underside of a table top.

In another exemplary embodiment of the present invention, the K-leg support includes adjustable levelers at the bottom end of the vertical back leg, and the front end of the lower front leg.

In another exemplary embodiment of the present invention, there is provided a work table comprising a table top and a pair of spaced-apart K-leg supports for supporting the table top. The table top has a top working surface. The working surface is preferably flat and may be generally horizontal or tilted at one or more inclined angles.

In a further exemplary embodiment of the present invention, the work table includes a rear brace attached lengthwise to a rear underside portion of the table top. A preferred rear brace is L-shaped and has a generally horizontal wall attached to the underside of the table top, and a vertical wall attached at or adjacent its ends to the vertical back legs of the K-leg supports. If desired, the work table may further comprise a front brace attached lengthwise to a front underside portion of the table top. A preferred front brace has a generally horizontal wall attached to the underside of the table top, and an angled wall that extends downwardly and rearwardly at about the same angle as the upper front leg of the K-leg supports and is attached at or adjacent its ends to the upper front legs of the K-leg supports.

In a further exemplary embodiment of the invention, the length of the upper and/or lower front legs and the back leg are adjustable so that the elevation of the working surface of the table top may be varied as desired. If desired, the length of the back leg may be adjusted so that the table top is inclined from the forward edge rearwardly and upwardly.

In yet another exemplary embodiment of the invention, there is provided one or more shelves above and across the rearward portion of the tabletop.

### BRIEF DESCRIPTION OF THE DRAWINGS

FIG. 1 is a perspective view of a high capacity work table with improved stability according to an exemplary embodiment of the present invention.

FIG. 2 is a perspective view of the K-leg support shown.

FIG. 3 is a side view of the K-leg support and table top of FIG. 1.

FIG. 4 is a perspective front underside view of a work table according to another exemplary embodiment of the present invention.

FIG. 5 is a perspective rear underside view of the work table of FIG. 4.

FIG. 6 is a perspective underside view of the work table of FIG. 4 that shows a K-leg support (in which foot plates are removed) partially folded under the table top.

FIG. 7 is another perspective underside view of the work table of FIG. 4 showing a K-leg support (with foot plates removed) completely folded under the table top.

FIG. 8 is yet another perspective underside view of the work table of FIG. 4 showing both K-leg supports (each having foot plates removed) folded under the table top.

FIG. 9 is a close-up perspective view of a hinge mechanism for attaching a K-leg support to the underside of a table top.

FIG. 10 is a side view of a K-leg support according to another exemplary embodiment of the present invention.

FIG. 11 is a side view of a K-leg support according to yet another exemplary embodiment of the present invention.

FIG. 12 is a side view of a K-leg support according to yet another exemplary embodiment of the present invention.

FIG. 13 is a perspective front underside view of a work table according to another exemplary embodiment of the present invention.

FIG. 14 is a side view of an exemplary embodiment of the present invention having an adjustable back leg.

FIG. 15 is a side view of an exemplary embodiment of the present invention having adjustable upper front legs and back legs.

FIG. 16 is a side view of an exemplary embodiment of the present invention having a shelf above and across the rearward portion of the table top.

FIG. 17 is a perspective front view of a work table according to another exemplary embodiment of the present invention.

FIG. 18 is a cross-sectional view of the legs of the work table of FIG. 17.

FIG. 19 is a perspective front view of a work table according to another exemplary embodiment of the present invention.

FIG. 20 is a perspective rear view of a work table of FIG. 19.

FIG. 21 is a perspective front view of a work table of FIG. 19.

FIG. 22 is an exploded view of an exemplary composite table top.

### DETAILED DESCRIPTION

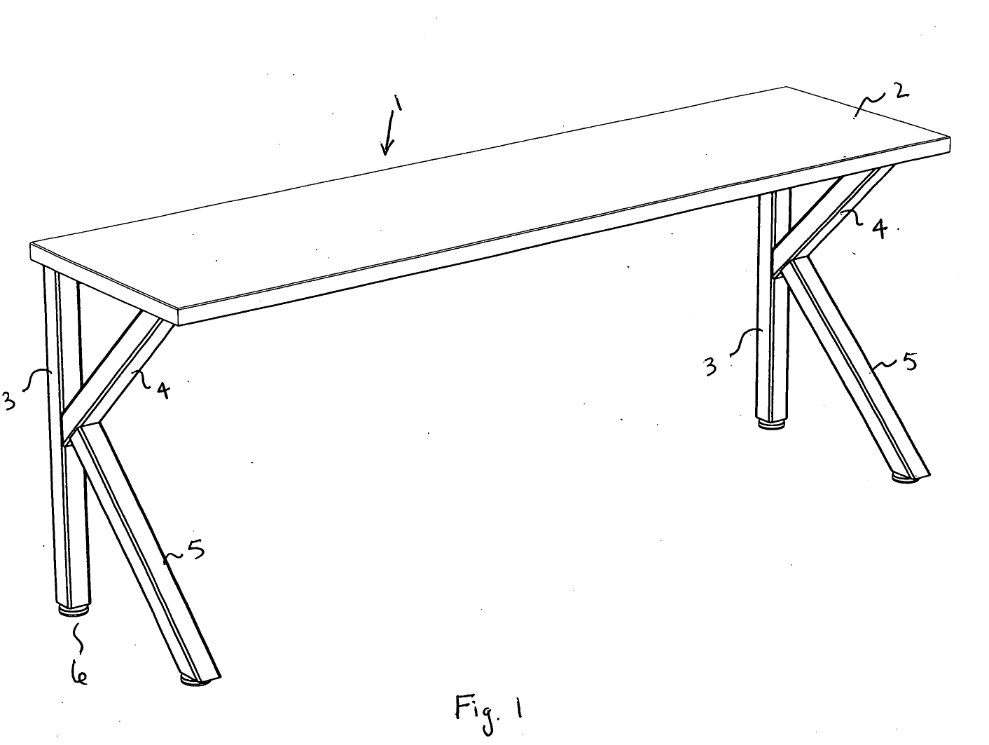

FIG. 1 shows an exemplary embodiment of a high capacity work table 1 with improved stability constructed in accordance with the present invention. The work table 1 includes a table top 2 and a pair of K-leg supports attached to the underside of the table top 2. Each K-leg support comprises a generally vertical back leg 3, upper front leg 4 extending from an upper front end downwardly and rearwardly to a lower rearward end that is fixedly attached to the vertical back leg 3, and a lower front leg 5 extending from a lower front end upwardly and rearwardly to a rearward end fixedly attached to a rearward portion of front leg 5. The back leg 3, upper front leg 4 and lower front leg 5 form a K-shaped support for supporting table top 2. The back leg 3, upper front leg 4 and lower front leg 5 may be made of any suitable material, e.g., steel tubing, plastic, etc.

The table top 2 may be formed of wood, metal, plastic or even materials such as granite and marble in various lengths, widths, and thicknesses.

In exemplary embodiments, the table top 2 is rectangular and has a length of about 36 inches, to about 96 inches and with a width of about 18 to about 48 inches. The thickness of the table top 2 may vary as desired according to the type of material from which the table top is made. In one exemplary embodiment the table top is made of hard wood, e.g., alder wood fashioned in a butcher-block style, and has a thickness of from about 1 to about 2 inches, and preferably of from about 1.125 to about 1.5 inches. In another exemplary embodiment, the table top is made of stainless steel and has a thickness of from about 0.25 to about 0.75 inches. In yet another exemplary embodiment, the table top is made of plastic having a thickness, preferably of from about 0.5 inch to about 1.5 inches. The type of plastic used is a matter of choice and may vary depending on the need for strength, rigidity, surface lubricating, chemical resistance and the like. A plastic table top may be made of lesser thickness strengthened by reinforcing walls, ribs or the like on the underside of the table top. The table top may be a composite structure having a base of one material, e.g., wood, metal or one type of plastic which is covered, coated or laminated with another material, e.g., a plastic laminate or coating material such as varnish. An exemplary embodiment of a composite table top is shown in FIG. 22. The top 2 has a wood base 50, preferably made of particle board or the like and a metal cladding 51, preferably of stainless steel sized to fit closely over the wood base. The metal cladding 51 includes a top wall 52, front wall 53, with a lower lip 54, that extends beneath the wood base 50, a pair of side walls 56 and a rear wall 57. The cladding 51 is installed over the wood base 50 by inserting the front edge of the wood base 50 into the channel formed by the top wall 52, front wall 53, and lower lip 54 and then lowering the rear portion of the cladding 51 until the top wall 52 of the cladding engages the top surface of the wood base 50. If desired, the metal cladding 51 can be secured to the wood base 50 by screws 58 or the like. It is understood that the dimensions and material of the table top may vary as desired and will depend at least in part on the applications for which the table is used.

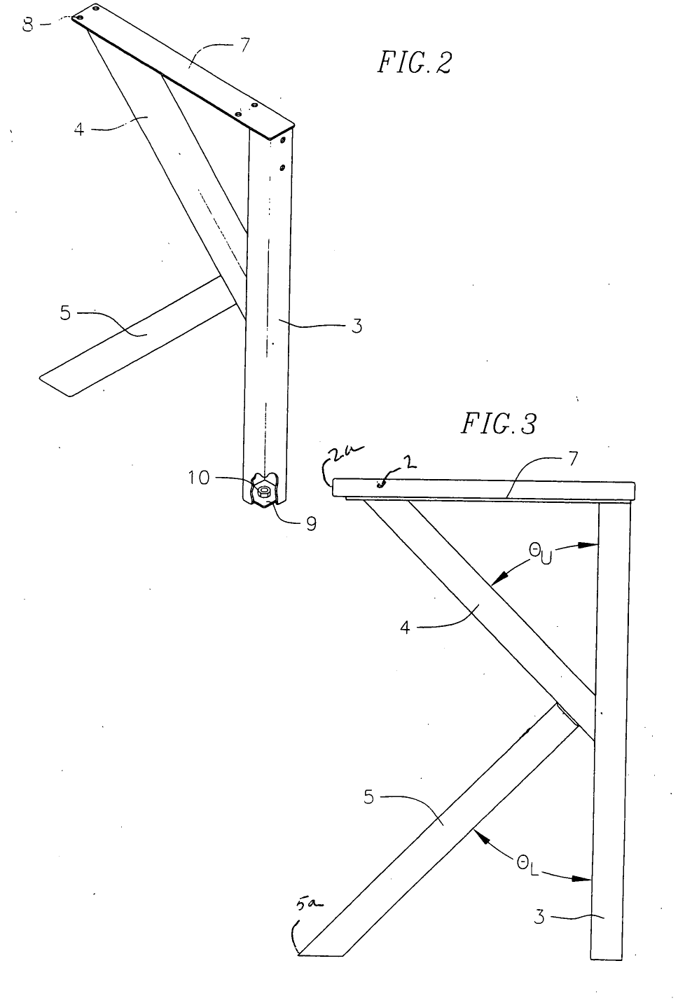

FIG. 2 shows the K-leg support of the worktable 1 according to an exemplary embodiment of the present invention. The K-leg support includes a vertical back leg 3, and upper front leg 4 and a lower front leg 5. In this embodiment, the legs 3, 4, and 5 of K-leg support are formed of tubular steel having a thickness of 0.083 inch and having a generally square 2.5 inch by 2.5 inch cross-sectional configuration. A presently preferred material is 0.083 inch steel tubing in a 2.5 inch by 2.5 inch square configuration. Attachment of the upper front, lower front and back legs to each other may be by any suitable means as is well known in the art. Welding is presently preferred. If the K-leg supports are made out of plastic, the support may be a single unit or molded structure or may be formed out of multiple components that are fastened together. A generally rectangular top plate 7, also made of steel connects the upper ends of the vertical back leg 3 and the upper front leg of 4, and includes holes 8 for allowing the K-leg support to be securely attached to the underside of the table top by bolts, screws or the like.

In the embodiment shown, levelers 6 are located at the bottom ends of the vertical back leg 3 and lower front leg 5. The levelers 6 contact a floor surface and may be adjusted for leveling the table top 2 surface. The levelers 6 comprise a plate 6a that is fixedly mounted within the bottom of the back leg 3 and front lower leg 5. The plate 6a includes an attached, e.g., welded, nut arranged to provide a threaded center hole. The levelers further comprise a circular foot plate 6b having a threaded center post that is threaded into the center hole of the plate. The elevation of the back or lower front leg can be adjusted by rotation of the circular footplate. It is understood that a leveler need not be present. If present, any suitable leveling mechanism is as well known in the art, may be used.

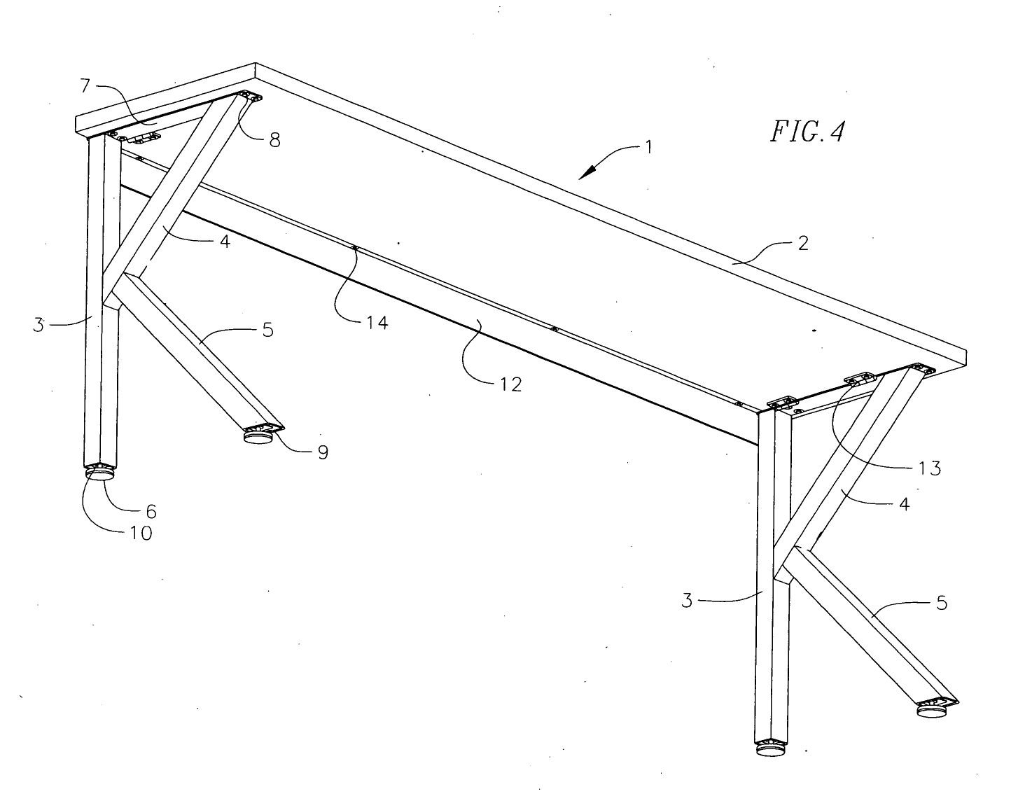

FIG. 3 shows a side view of the K-leg support according to an exemplary embodiment of the present invention. In this embodiment, the vertical back leg 3 has a length of about 35 inches, the upper front leg 4 has a length of about 26 inches, the lower front leg 5 has a length of about 27⅝ inches. The top plate 7 connects and the vertical back leg 3 and the upper front leg 4. The upper front leg 4 extends from the vertical back leg 3 at an angle of θ_{U} of about 45° from about 30° to about 60°, more usually from about 40° to about 50°. The lower front leg 5 connects to a rearward portion of the upper front leg 4 at an angle, θ_{L,} to the back leg 3 of about 45°. It is understood that the angles of θ_{U} and θ_{L} will vary depending on, for example, the overall height and width of the K-leg support which will in large part depend on the desired height of the table and the width of the table top. Typically, θ_{U} and θ_{L} will be from about 30° to about 60°, more usually from about 40° to about 50°.

In the embodiment of the present invention shown in FIG. 3, the front edge 5a of the lower front leg 5 extends forwardly beyond the front edge 2a of the table top 2 a distance of about 1-2 inches. It is understood that, whether the front end of the lower front leg extends forwardly beyond the front edge of the table top 2 is a matter of choice and will typically depend on the need for the added stability that can be achieved by the forward placement of the front end of the lower front leg. For example, if the table top is expected to carry exceedingly heavy loads adjacent its front edge, a lower front leg that extends to and, if desired, beyond the front edge of the table tops adjusting preferably in the range of about 2 to about 6 inches will provide the additional stability required for such a load.

While specific exemplary dimensions were described in relation to FIG. 3, the dimensions of the vertical back leg 3, upper front leg 4, and lower front leg 5 as well as angles θ_{U} and θ_{L} may vary as desired. In other words, the invention encompasses all of the embodiments encapsulated by the various parameters of the work bench, with the only limitation being that the leg supports maintain a K-shaped form. The various parameters include variable table top widths, vertical back leg heights, locations of attachment of the upper front leg to the vertical back leg, locations of attachment of the lower front leg to the upper front leg, and lengths to which the lower front leg extends beyond the table top.

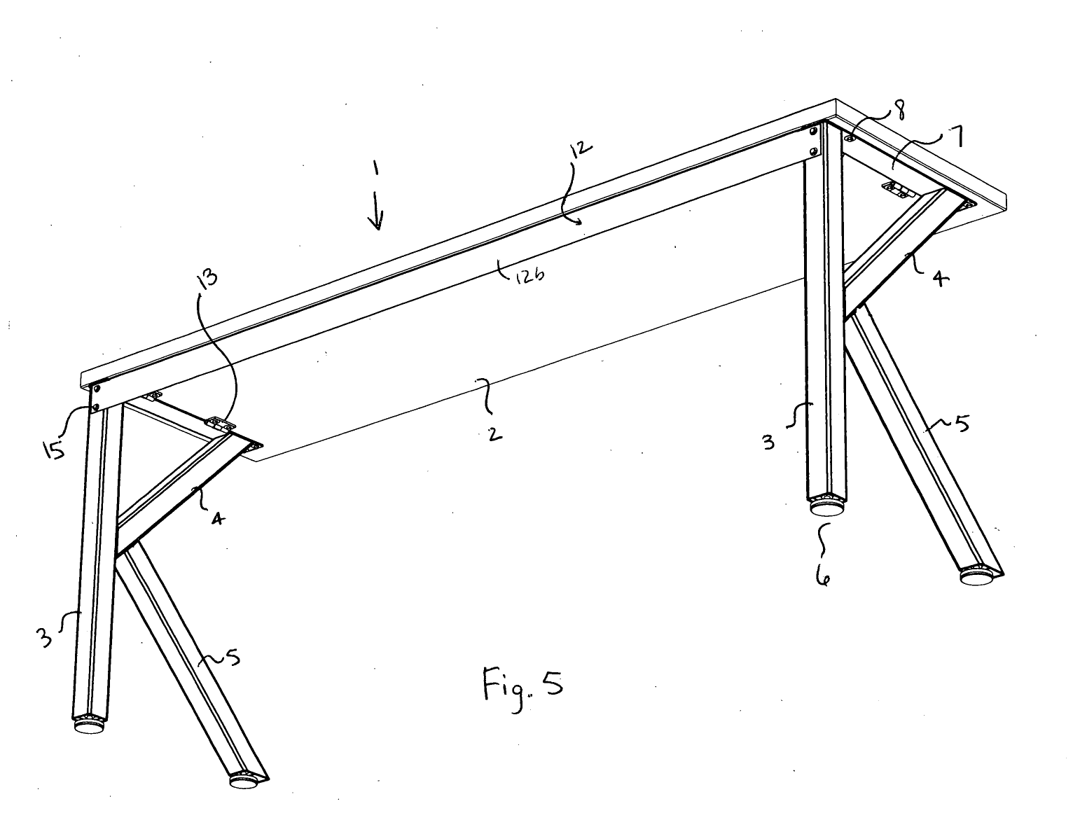

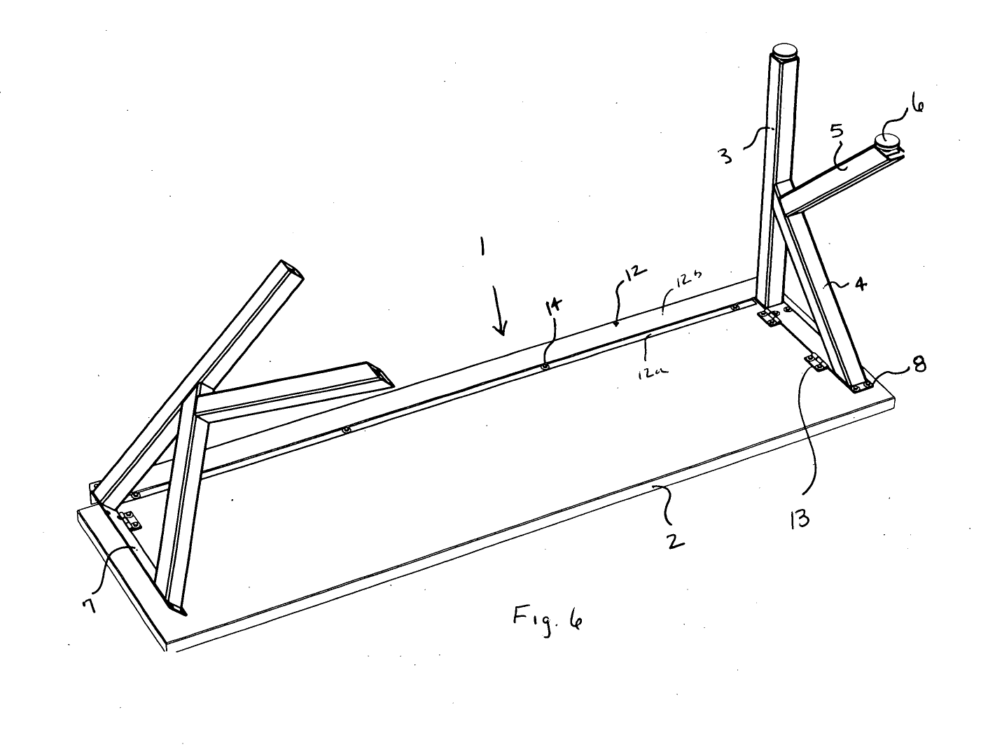

FIGS. 4 and 5 show an underside of the work table 1 according to an exemplary embodiment of the present invention. In this embodiment, the work table 1 includes a rear brace 12 connected to the table top 2 and the vertical back legs 3 for supporting a back portion of the table top 2. The rear brace 12 is generally L-shaped and includes a horizontal wall 12a having a plurality of holes 14 spaced apart for attachment to the underside of the table top 2 by means of screws, bolts or the like, and a vertical wall 12b having holes 15 at it ends for attachment to the vertical back legs 3. In an exemplary embodiment, the rear brace 12 is made of 0.083 inch steel.

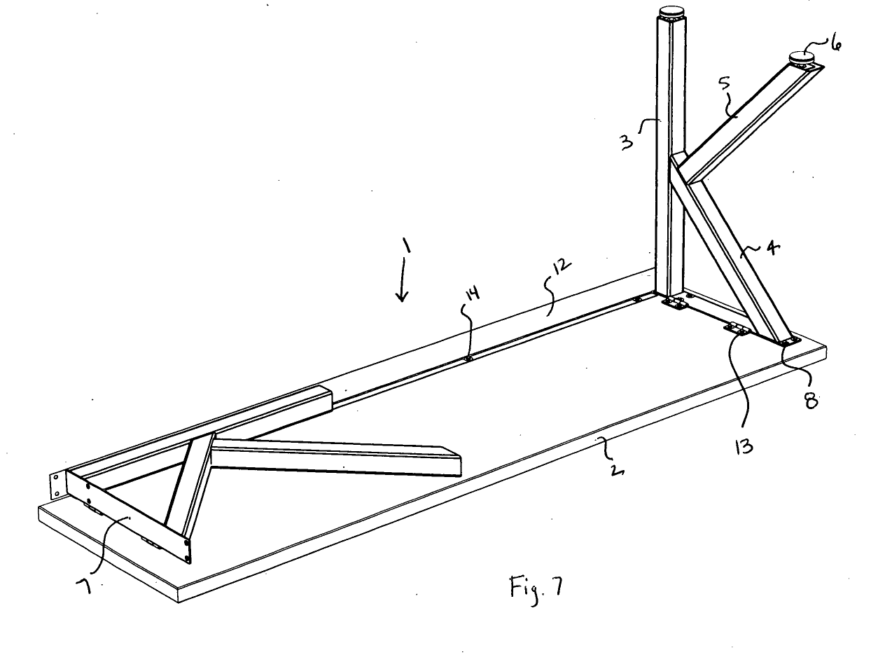

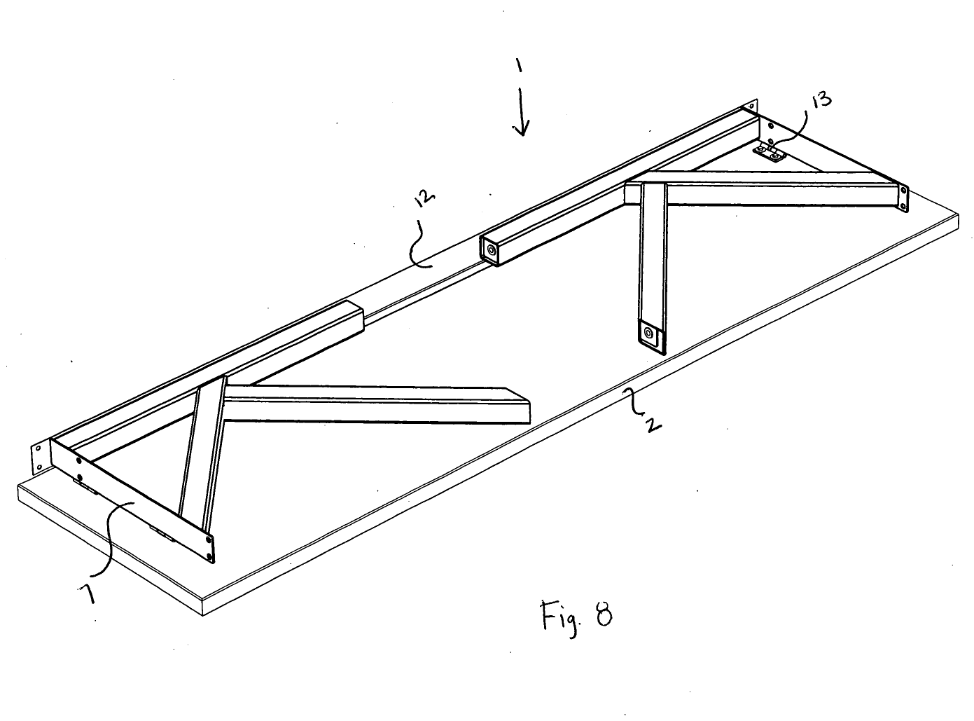

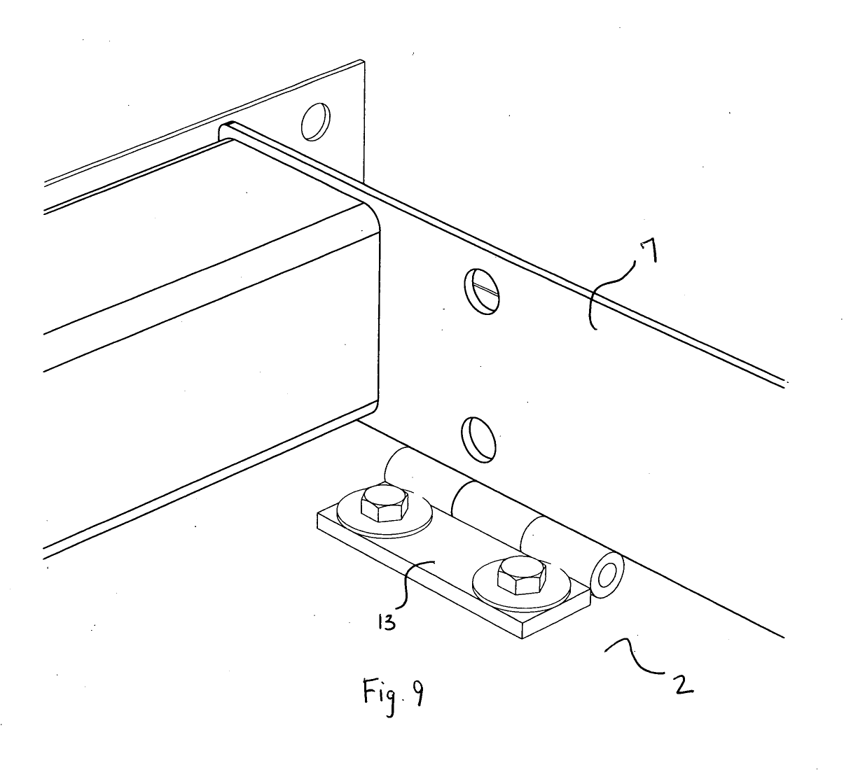

As shown in FIGS. 6-9, the top plate 7 includes a pair of hinged flanges 13 for allowing the K-leg supports to fold onto the underside of the table top 2 for storage. The legs can be releasably held in their folded position by any conventional means, e.g., spring clip, strap, or the like. FIGS. 6-9 show how the K-shaped braces pivot from an open position to a storage position adjacent the underside of the table top 2. The hinged flanges 13 comprise holes for attachment to the underside of the table top 2 by screws, bolts, or the like. It is understood that the number and length of the hinged flanges may vary as desired. It is also understood that the hinge may be a separate component from the top plate 7. That is, the hinge may have one flange attachable to the top plate and a second flange attachable to the underside of the table top. As shown in 7, the top plate 7 is secured to the underside of the table top by bolts, screws or the like. The bolts, screws or the like must be removed to fold the K-legs to their storage positions. It is understood that a mechanism for securing the top plate to the underside of the table top is not required to produce the invention. If present, any such mechanism may be used. Alternatively, the K-legs may be held in their open positions by the rear or front braces or simply by the weight of the table.

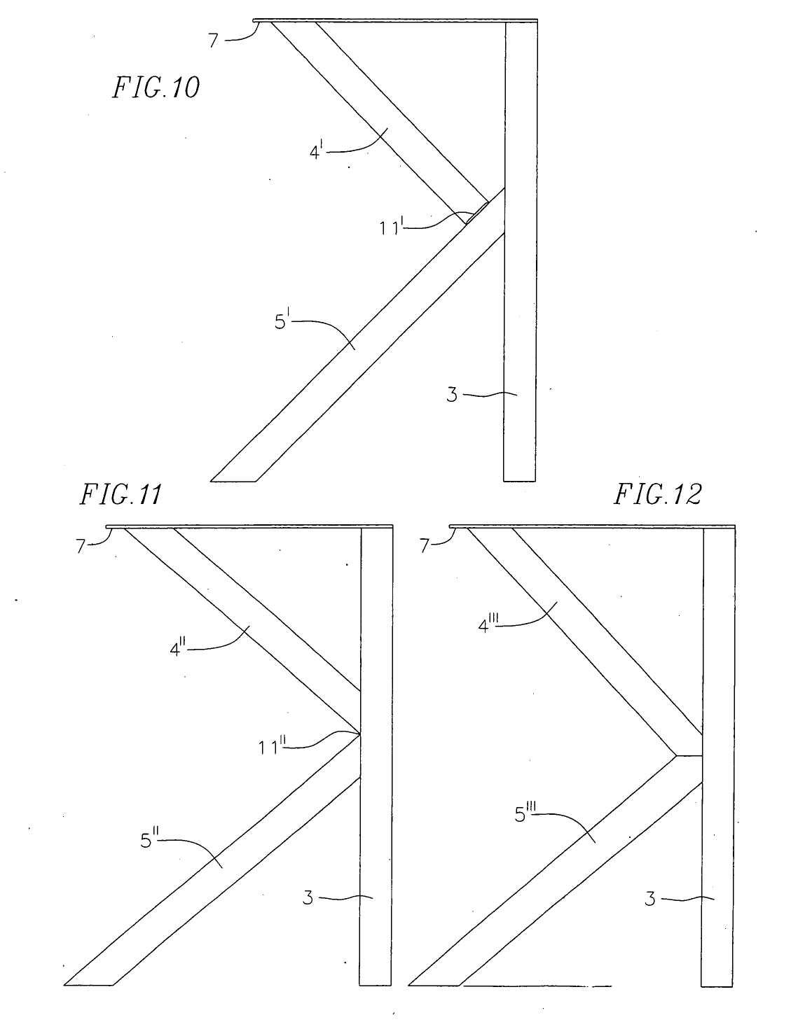

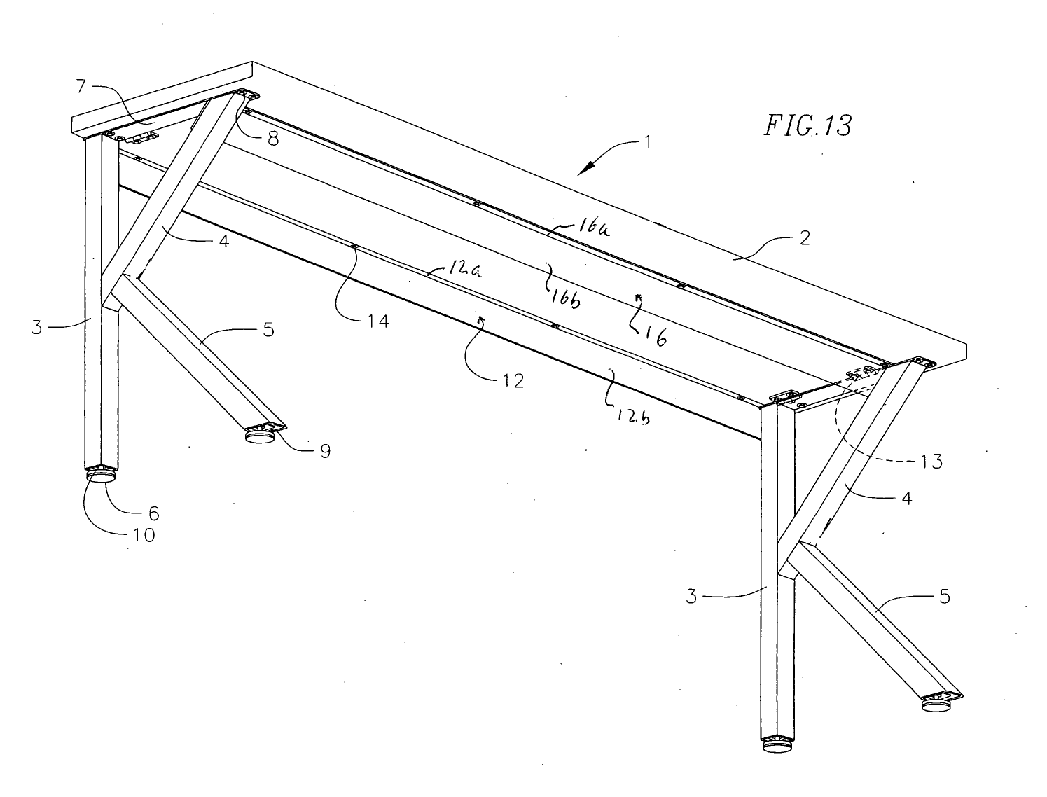

FIGS. 10, 11, and 12 show side views of K-shaped braces according to other exemplary embodiments of the present invention. As shown in FIG. 10, the lower front leg 5 may be attached to the vertical back leg 3, and the upper front leg 4′ may be attached to the lower front leg 5′. As shown in FIG. 11, both the lower front leg 5″ and the upper front leg 4″ may be directly attached to the vertical back leg 3. As shown in FIG. 12, the lower front leg 5′″ and the upper front leg 4′″ may be directly attached to the vertical back leg and to each other.

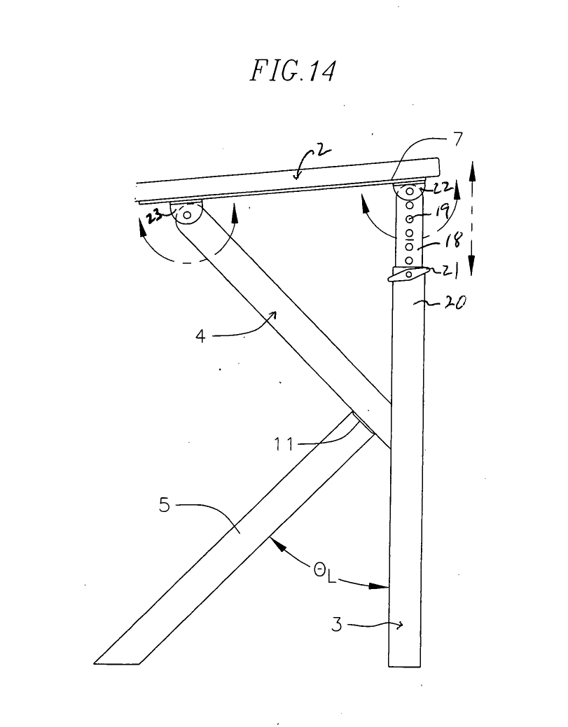

FIG. 13 shows an underside of a work table 1 according to another exemplary embodiment of the present invention. In this embodiment, the work table 1 comprises a front brace 16 attached lengthwise to a front underside portion of the table top 2. The front brace 16 has a generally horizontal wall 16a attached to the underside of the table top 2 in a manner similar to that of the rear brace 12. The front brace 16 also has an angled wall 16b that extends downwardly and rearwardly at about the same angle as the upper front leg 4 of the K-leg supports and is attached at or adjacent its ends to the upper front legs 4 of the K-leg supports in a manner similar to the attachment of the rear brace 12 to the back legs 3. In an exemplary embodiment, the front brace 16 is made of 0.083 inch steel. It is understood that the front and rear braces 12 and 16 are optional and may be used together, separately, or not at all.

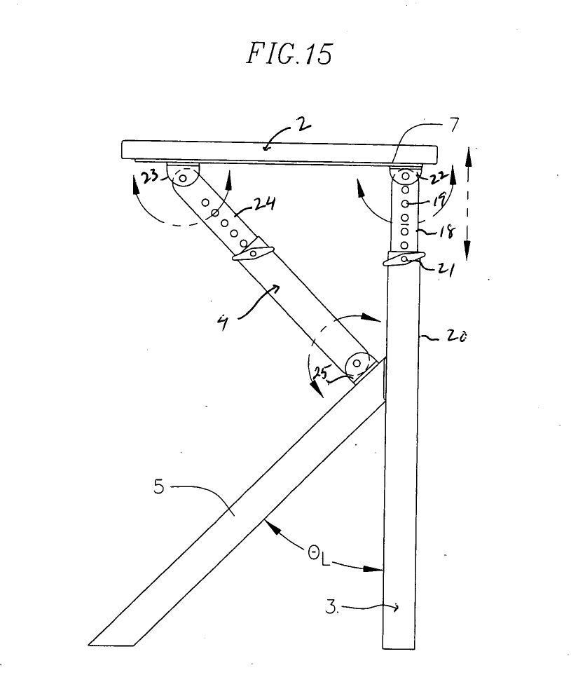

In yet another exemplary embodiment of the invention, the length of the back leg 3 is adjustable. That is, the height of the back leg 3 can be adjusted to provide a tilt to the table top which may be desirable for certain applications. Any suitable mechanism for adjusting the length of the back leg 3 may be used. One example of an adjustable back leg 3 is shown in FIG. 14. The back leg 3 includes an inner telescoping tube 18 that can be secured at various elevations by matching holes 19 along its length with a hole in an outer tube 20 and insertion of a pin 21 or bolt through the holes to “lock” the inner tube 18 at a specific elevation. In the embodiment shown, the inner tube 18 of the back leg 3 and the upper end of the upper leg 4 are pivotally attached to the underside of the table top by a pivoting bracket 22 (as shown), or by hinges, or the like, as is well known in the art.

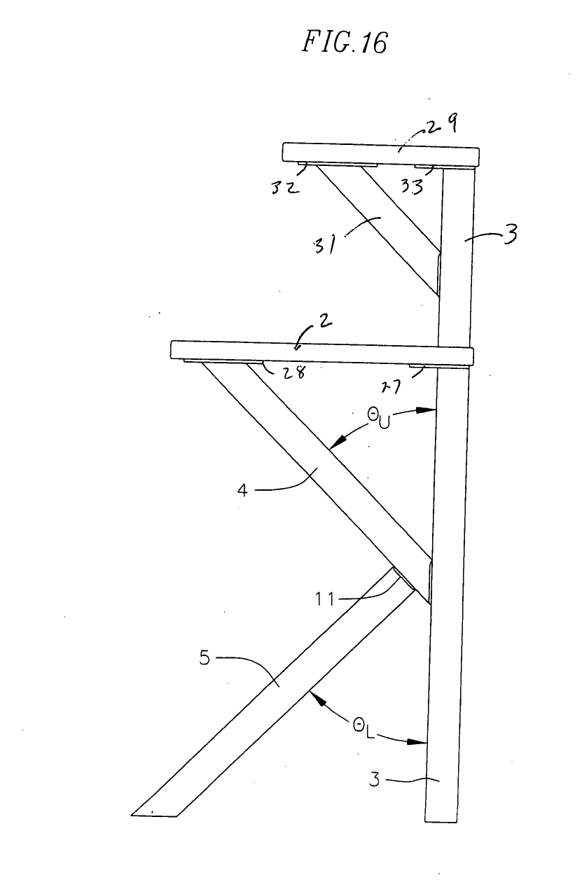

In another exemplary embodiment of the invention, the lengths of both the back leg 3 and upper front leg 4 are adjustable. One example of this is shown in FIG. 15, where both the back leg 3 and upper front leg have inner telescoping tubes 18 and 24. Both are hingedly attached by pivoting brackets 22 and 23 on an upper plate 24. In this embodiment, the lower front leg 5 is attached directly to the back leg 3 and the upper front leg 4 is hingedly attached by a pivot bracket 25 to a rearward portion of the lower front leg 5.

If desired, the work table 1 can include one or more shelves 26 above and across a rearward portion of the table top 2. In one such exemplary embodiment, the rear legs 3 extend upwardly through notches or holes in the table top 2. In this embodiment, the back leg 3 and upper front leg 4 have flanges 27 and 28 respectively at their upper ends for attachment to the table top 2. A shelf 29, typically made of the same material as the table top 2, is mounted at the top of the back legs 3. In the embodiment shown, a shelf brace 31 extends forwardly and upwardly from the back leg 3, at a position above the table top 2, to the underside of the shelf 26 for added support. Flanges 32 and 33 are provided for attaching the top ends of the brace 31 and back leg 3 to the shelf. The flanges 32 and 33 includes holes for attachment to the shelf 26 by bolts, screws or the like. It is understood that the shelf may be attached to the top of the back leg 3 by any suitable means. For example, the top end of the back leg 3 and, brace 31, could include a single top plate connecting the two and having holes for attachment to the shelf by bolts, screws, or the like. It is further understood that if one or more shelves are desired, any support for this shelf could be used as is well known in the art.

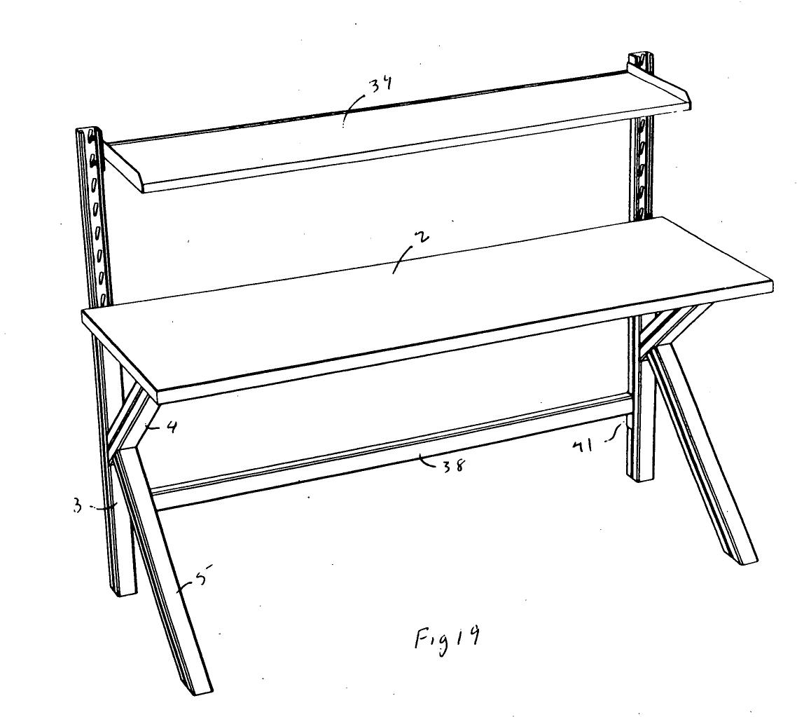

FIG. 17 shows yet another embodiment of the invention. In this embodiment, the back leg 3, upper front leg 4 and lower front leg 5 have front and back sections “a” and “b” formed by a pair of standard boltless support posts connected together, e.g., by welding or the like, as shown in cross section in FIG. 18. The back sections (“b”) comprise slots for receiving tabs, rivets or the like. The front section “a” may comprise slots if desired. The slot pattern may be any suitable pattern including those that are well known in conventional boltless rack constructions.

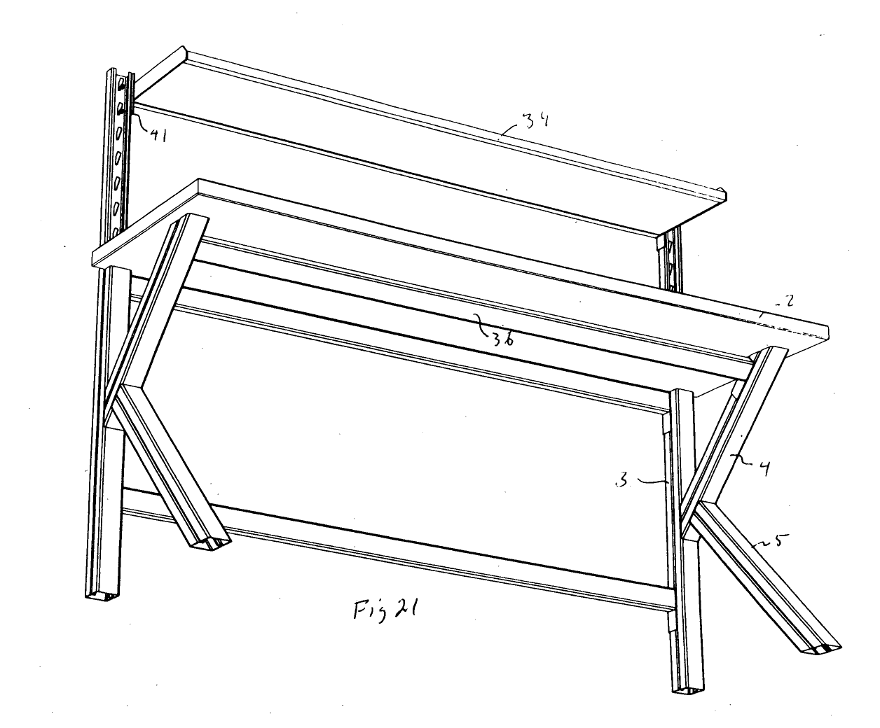

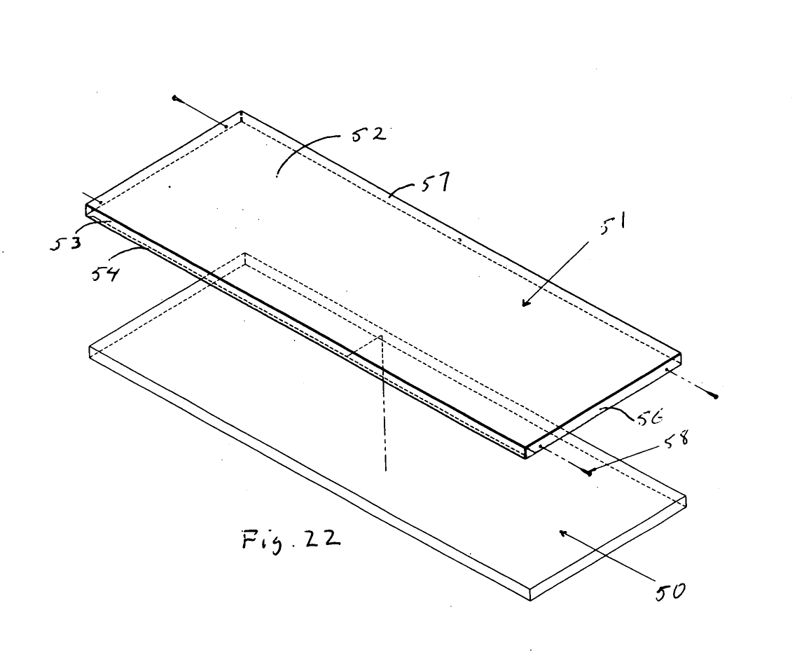

In the embodiments shown in FIGS. 17 and 19-21, the slots receive tabs that have been “punched” in brackets 41 at the ends of front and rear upper and lower braces 36, 37 and 38. This enables the front brace 36 and rear upper and lower braces 37 and 38 to be attachable and detachable at their ends to the upper front leg 5 and back leg 3 by conventional boltless attachment.

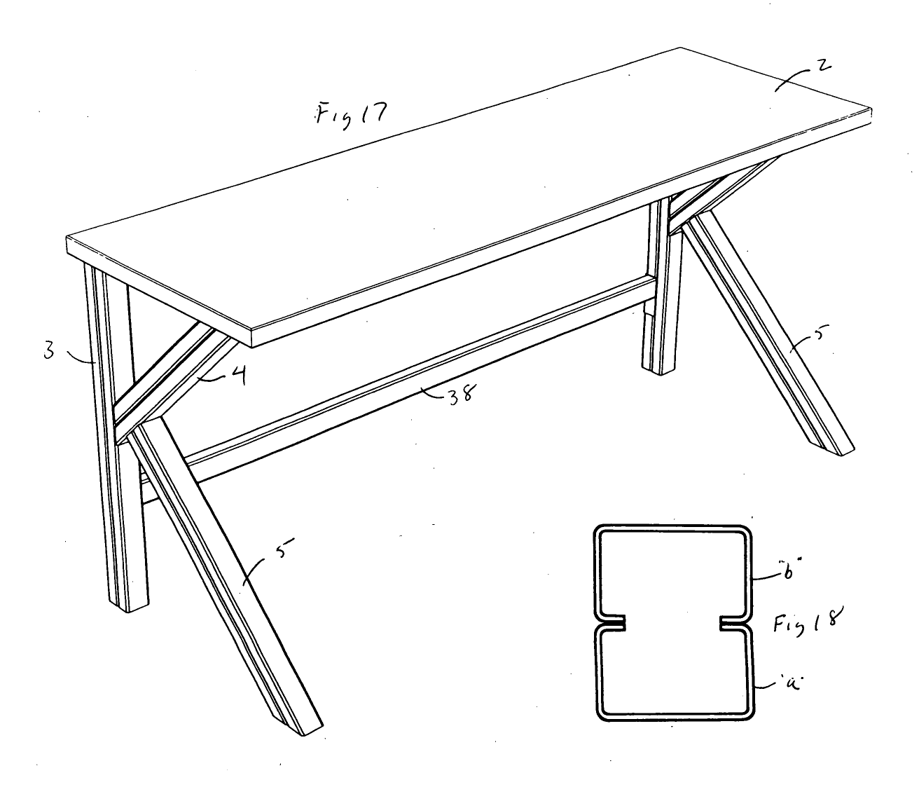

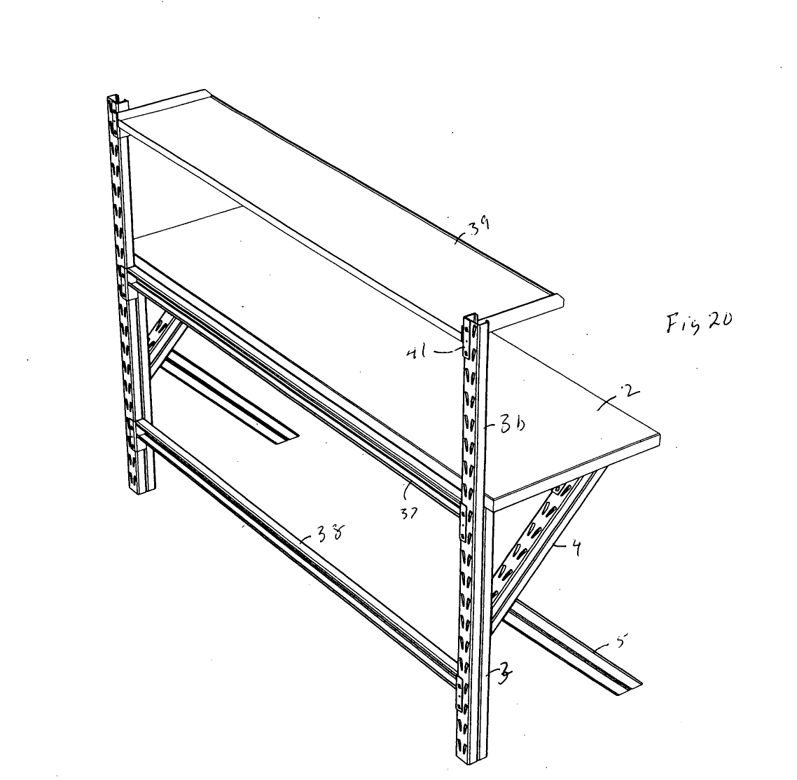

In the embodiment shown in FIGS. 19-21, the front section 3a of the back leg 3 extends only to the bottom surface of the table top 2 and, along with upper rear brace 38, provides support for the rear portion of table top 2. The front portion of table top 2 is supported by the top ends of upper front leg 4 and the front brace 36. The back section 3b of the back leg 3 extends upwardly past the table top 2 to an elevation sufficient to support a shelf 39 above the table top 2. The shelf 39 may be a single unitary construction, as shown, including flanges 41 that carry tabs, rivets or the like for insertion into and seating in the slots of the back leg 3b. Alternatively the shelf may comprise a panel made of wood, metal, plastic or any other suitable material, that is supported by end brackets that are mounted, preferably boltlessly, on the back leg 3b, by a fixed braces similar to braces 31 described with respect to the embodiment of FIG. 16 or by any other suitable means.

It is understood that the work table of the present invention may include one or more drawers mounted below the table top. Mechanisms for slidably mounting drawers below a work bench or work surface are well known in the art. Alternatively or in addition, the work table may include electrical wiring and connections for providing a convenient outlet or other electrical connection below, adjacent or built into the table top. Such electrical wiring may extend through one or more of the tubular legs for protection and for aesthetic purposes.

While the invention has been described in terms of exemplary embodiments, it is to be understood that the words which have been used are words of description and not of limitation. As is understood by persons of ordinary skill in the art, a variety of modifications can be made without departing from the scope of the invention defined by the following claims, which should be given their fullest, fair scope.

What is claimed is:

1. A K-shaped support for a table top comprising:
a generally vertical back leg;
an upper front leg extending from a forward end downwardly and rearwardly to a rearward end;
a lower front leg extending from a forward end upwardly and rearwardly to a rearward end;
wherein the rearward end of the upper front leg is fixedly attached to at least one of the back leg and a rearward portion of the lower front leg and the rearward end of the lower front leg is fixedly attached to at least one of the back legs and a rearward portion of the upper front leg.

2. A K-shaped support as recited in claim 1 further comprising a generally flat plate attached to and extending between the upper end of the back leg and the forward end of the upper front leg.

3. A K-shaped support as recited in claim 1 wherein the length of the back leg is adjustable.

4. A K-shaped support as recited in claim 1 wherein the lengths of the back leg and at least one of the upper front leg and lower front leg are adjustable.

5. A K-shaped support as recited in claim 1 further comprising adjustable levelers at the bottom end of the back leg and the forward end of the lower front leg.

6. A K-shaped support as recited in claim 1 wherein the angle between the back leg and the upper front leg is from about 30° to about 60°.

7. A K-shaped support as recited in claim 1 wherein the angle between the back leg and the lower front leg is from about 30° to about 60°.

8. A K-shaped support as recited in claim 1 wherein the angle between the back leg and the upper front leg is from about 40° to about 50°.

9. A K-shaped support as recited in claim 1 wherein the angle between the back leg and the lower front leg is from about 40° to about 50°.

10. A K-shaped support as recited in claim 1 wherein the upper front leg is attached directly to the back leg and the lower front leg is attached to the rearward portion of the upper front leg.

11. A K-shaped support as recited in claim 1 wherein the lower front leg is attached directly to the back leg and the upper front leg is attached to a rearward portion of the first lower front leg.

12. A K-shaped support as recited in claim 1 wherein each of the upper front leg and lower front leg is directly attached to the back leg.

13. A work table comprising:
a table top;
first and second K-leg supports attached to a left and right underside portion of the table top, each K-leg support including:
a generally vertical back leg;
an upper front leg extending from a front end downwardly and rearwardly to a rearward end;
a lower front leg extending from a front end upwardly and rearwardly to a rearward end;
wherein the rearward end of the upper front leg is fixedly attached to at least one of the back legs and a rearward portion of the lower front leg and the rearward end of the lower front leg is fixedly attached to at least one of the back legs and a rearward portion of the upper front leg.

14. The work table as claimed in claim 13, wherein the upper front leg is attached directly to the back leg and the lower front leg is attached to a rearward portion of the upper front leg.

15. The work table as claimed in claim 13, wherein the lower front leg is attached directly to the back leg and the upper front leg is attached to a rearward portion of the first lower front leg.

16. The work table as claimed in claim 13 wherein each of the upper front leg and lower front leg is directly attached to the back leg.

17. The work table as claimed in claim 13, wherein the lower front leg and each of the first and second K-leg supports extend forwardly beyond the front edge of the table top.

18. The work table as claimed in claim 17, wherein the lower front leg and each of the first and second K-leg supports extend forwardly beyond the front edge of the table top a distance of from about 1 to about 2 inches.

19. The work table as claimed in claim 13 further comprising at least one rear brace.

20. The work table as claimed in claim 13 further comprising at least one front brace.

21. The work table as claimed in claim 13 further comprising at least one shelf extending above and across at least a portion of the table top.

22. The work table as claimed in claim 21 wherein the height of the shelf is adjustable.

23. The work table as claimed in claim 13 wherein the lengths of the back legs are adjustable.

24. The work table as claimed in claim 13 wherein the length of the back legs and upper front legs are adjustable.

25. The work table as claimed in claim 13 wherein the table top has a composite structure comprising a wood base and a metal cladding.
